(19) United States
(12) Patent Application Publication
(10) Pub. No.: US 2018/0236810 A1
(43) Pub. Date: Aug. 23, 2018

(54) VEHICLE WHEEL

(71) Applicant: TOPY KOGYO KABUSHIKI KAISHA, Tokyo (JP)

(72) Inventor: Yoshinari INAGAKI, Toyohashi-shi, Aichi-ken (JP)

(73) Assignee: TOPY KOGYO KABUSHIKI KAISHA, Tokyo (JP)

(21) Appl. No.: 15/764,383

(22) PCT Filed: Sep. 27, 2016
(86) PCT No.: PCT/JP2016/078343

§ 371 Date: Mar. 29, 2018

(30) Foreign Application Priority Data
Sep. 29, 2015 (JP) 2015-191054

(51) Int. Cl. B60B 3/04; B60B 25/00

(52) U.S. Cl. CPC B60B 3/044; B60B 21/104; B60B 3/045; B60B 25/004

(57) ABSTRACT

A coupling structure for coupling first and second wheel pieces includes (a) a radially-positioning coupling including a radially-positioning protrusion and a radially-positioning recess, (b) a circumferentially-positioning coupling including a circumference protrusion and a circumference protrusion-receiving recess and (c) an axially-positioning coupling including an arm and a claw receiver. As a result, even eliminating welding and coupling by a bolt, it is possible to couple the first and second wheel pieces securely by a physical coupling such as fitting, engaging, inserting and press-fitting.

### CROSS REFERENCE TO RELATED APPLICATIONS

This application is a National Phase filing under 35 U.S.C. § 371 of PCT/JP2016/078343 filed on Sep. 27, 2016, and this application claims priority to Application No. 2015-191054 filed in Japan on Sep. 29, 2015 under 35 U.S.C. § 119; the entire contents of all are hereby incorporated by reference.

The present invention relates to a vehicle wheel, and more particularly, to a two-piece wheel for a vehicle constructed of two pieces.

### BACKGROUND

The prior art discloses coupling of wheel pieces by welding and using a bolt.

As shown in FIG. 16, Patent Document 1 discloses a vehicle wheel having a first wheel piece 101 and a second wheel piece 102, where the first and second wheel pieces 101 and 102 are coupled to each other by welding W.

As shown in FIG. 17, Patent Document 2 discloses a vehicle wheel having a first wheel piece 201 and a second wheel piece 202, where the first and second wheel pieces 201 and 102 are coupled to each other by a bolt B.

The vehicle wheels disclosed in the above publications have the following problems:

(i) Patent Document 1

Due to welding, it is impossible to couple wheel pieces made from different materials (e.g., Fe, Al, Mg, etc.) because the materials have different melting points and a coupling strength therebetween is low. In addition, a countermeasure for preventing electrolytic corrosion from occurring is required.

(ii) Patent Document 2

When coupling using a bolt, a risk of shear failure or fatigue failure of the bolt due to a rotational torque is relatively high. For this reason, in current commercial wheels, almost all coupling by bolts is reinforced with welding. Further, when coupling using a bolt, the number of parts is large, and the man-hours for conducting the coupling leads to cost increase.

### PRIOR TECHNICAL DOCUMENTS

### Patent Documents

Patent Document 1: Japanese Patent Publication 2002-144802
Patent Document 2: Japanese Patent No. 3990283

### SUMMARY OF THE INVENTION

### Problems to be Solved by the Invention

An object of the present invention is to provide a vehicle wheel where neither welding nor coupling by a bolt is required for coupling wheel pieces of the wheel.

### Means for Solving the Problems

The present invention for achieving the above object includes a vehicle wheel comprising a rim and a disk. The rim includes an outboard rim flange, an outboard rim bead seat, a rim drop, an inboard rim bead seat and an inboard rim flange.

The wheel is constructed by coupling a first wheel piece and a second wheel piece to each other by using a coupling structure. The first wheel piece includes a portion of the rim including at least the inboard rim flange. The second wheel piece includes a remaining portion of the rim and the disk.

The coupling structure includes (a) a radially-positioning coupling for radially positioning the first wheel piece and the second wheel piece relative to each other in a radial direction of the wheel, (b) a circumferentially-positioning coupling for preventing the first wheel piece and the second wheel piece from moving relative to each other in a circumferential direction of the wheel and (c) an axially-positioning coupling for preventing the first wheel piece and the second wheel piece from moving relative to each other in an axial direction of the wheel.

The radially-positioning coupling includes a radially-positioning protrusion protruding in the axial direction of the wheel from one of the first and second wheel pieces and a radially-positioning recess, provided at the other of the first and second wheel pieces, for receiving the radially-positioning protrusion.

The circumferentially-positioning coupling includes a circumference protrusion protruding in the axial or radial direction of the wheel from a circumferentially one portion of one of the first and second wheel pieces and a circumference protrusion-receiving recess, provided at the other of the first and second wheel pieces, for receiving the partial circumference protrusion.

The axially-positioning coupling includes an arm extending in the axial direction of the wheel from one of the first and second wheel pieces and having a claw bulging out in the radial direction of the wheel at a tip of the arm and a claw receiver, provided at the other of the first and second wheel pieces, for engaging the claw in the axial direction of the wheel.

The vehicle wheel as described above may be formed such that a material of the first wheel piece and a material of the second wheel piece are different from each other.

The vehicle wheel as described above may be formed such that a sealant is disposed between the first wheel piece and the second wheel piece.

### Technical Advantages of the Invention

According to a vehicle wheel as described above, the coupling structure includes the radially-positioning coupling, the circumferentially-positioning coupling and the axially-positioning coupling. The radially-positioning coupling includes the radially-positioning protrusion and the radially-positioning recess. The circumferentially-positioning coupling includes the circumference protrusion and the circumference protrusion-receiving recess. The axially-positioning coupling includes the arm and the claw receiver. Therefore, even if welding and coupling by a bolt are eliminated, the first and second wheel pieces can be coupled together by a physical assembly (assembly by fitting, engaging, inserting, press-fitting, etc.).

As a result, in spite of eliminating welding and coupling by a bolt, it is possible to couple the first and second wheel pieces by the above physical assembly, so that compared with the case where welding and coupling by a bolt, the man-hour required for the coupling can be reduced. Since welding can be eliminated in coupling the first and second wheel pieces, it is also possible to couple the first and second wheel pieces made from different materials, for example, a combination of different metals, or a combination of a resin such as CFRP (carbon fiber reinforced plastic) and a metal. Since the coupling by a bolt can be eliminated in coupling the first and second wheel pieces, it is possible to eliminate a risk of occurrence of breakage of the bolt.

Even when the materials of the first and second wheel portions are different from each other, the beneficial effects described above can be obtained.

When sealant is disposed between the first wheel piece and the second wheel piece, even when the materials of the first and second wheel pieces are different from each other, the risk of electrolytic corrosion due to contact of different metals can be reduced as compared with the conventional wheel. In addition, since it is possible to paint the pieces beforehand, the risk of electrolytic corrosion due to contact of different metals can be further reduced.

### BRIEF DESCRIPTION OF THE DRAWINGS

FIG. 1 is a perspective view of a vehicle wheel according to a first embodiment of the present invention.

FIG. 2 is a cross-sectional view of a vehicle wheel according to the first embodiment of the present invention.

FIG. 3 is a group of partial views of a coupling structure for coupling first and second wheel pieces of a vehicle wheel according to the first embodiment of the present invention wherein: FIG. 3(a) is a partial cross-sectional view of a wheel portion where a circumferentially-positioning coupling is not provided; FIG. 3(b) is a partial cross-sectional view of wheel portions where the circumferentially-positioning coupling is not provided and the circumferentially-positioning coupling is provided; and FIG. 3(c) is a partial cross-sectional view of a wheel portion where the circumferentially-positioning coupling is provided.

FIG. 4 is a partial cross-sectional view of the wheel portion shown in FIG. 3(c) along line A-A.

FIG. 5 is a group of partial views of a coupling structure for coupling the first and second wheel pieces, of the vehicle wheel according to a second embodiment of the present invention wherein: FIG. 5(a) is a partial cross-sectional view of a wheel portion where a circumferentially-positioning coupling is not provided; FIG. 5(b) is a partial perspective view of wheel portions where the circumferentially-positioning coupling is not provided and the circumferentially-positioning coupling is provided; and FIG. 5(c) is a partial cross-sectional view of a wheel portion where the circumferentially-positioning coupling is provided.

FIG. 6 is a partial cross-sectional view of the wheel portion shown in FIG. 5(c) along line B-B.

FIG. 7 is a group of partial views of a coupling structure for coupling the first and second wheel pieces, of the vehicle wheel according to a third embodiment of the present invention wherein: FIG. 7(a) is a partial cross-sectional view of a wheel portion where a circumferentially-positioning coupling is not provided; FIG. 7(b) is a partial perspective view of wheel portions where the circumferentially-positioning coupling is not provided and the circumferentially-positioning coupling is provided, and FIG. 7(c) is a partial cross-sectional view of a wheel portion where the circumferentially-positioning coupling is provided.

FIG. 8 is a partial cross-sectional view of the wheel portion shown in FIG. 7(c) along line C-C.

FIG. 9 is a group of partial views of a coupling structure for coupling the first and second wheel pieces, of the vehicle wheel according to a fourth embodiment of the present invention wherein: FIG. 9(a) is a partial cross-sectional view of a wheel portion where a circumferentially-positioning coupling is not provided; FIG. 9(b) is a partial perspective view of wheel portions where the circumferentially-positioning coupling is not provided and the circumferentially-positioning coupling is provided; and FIG. 9(c) is a partial cross-sectional view of a wheel portion where the circumferentially-positioning coupling is provided.

FIG. 10 is a partial cross-sectional view of the wheel portion shown in FIG. 9(c) along line D-D.

FIG. 11 is a group of partial views of a coupling structure for coupling the first and second wheel pieces, of the vehicle wheel according to a fifth embodiment of the present invention wherein: FIG. 11(a) is a partial cross-sectional view of a wheel portion where a circumferentially-positioning coupling is not provided; FIG. 11(b) is a partial perspective view of wheel portions where the circumferentially-positioning coupling is not provided and the circumferentially-positioning coupling is provided; and FIG. 11(c) is a partial cross-sectional view of a wheel portion where the circumferentially-positioning coupling is provided.

FIG. 12 is a partial cross-sectional view of the wheel portion shown in FIG. 11(c) along line E-E.

FIG. 13 is a partial cross-sectional view of the wheel portion shown in FIG. 11(c) along line F-F.

FIG. 14 is a partial cross-sectional view of a coupling structure for coupling the first and second wheel pieces, of the vehicle wheel according to a sixth embodiment of the present invention.

FIG. 15 is a partial cross-sectional view of the wheel portion shown in FIG. 14 along line G-G.

FIG. 16 is a cross-sectional view of a conventional vehicle wheel of a welding type.

FIG. 17 is a cross-sectional view of a conventional vehicle wheel of a bolt-coupling type.

### DETAILED DESCRIPTION OF THE PREFERRED EMBODIMENTS

Vehicle wheels according to embodiments of the present invention will be described below.

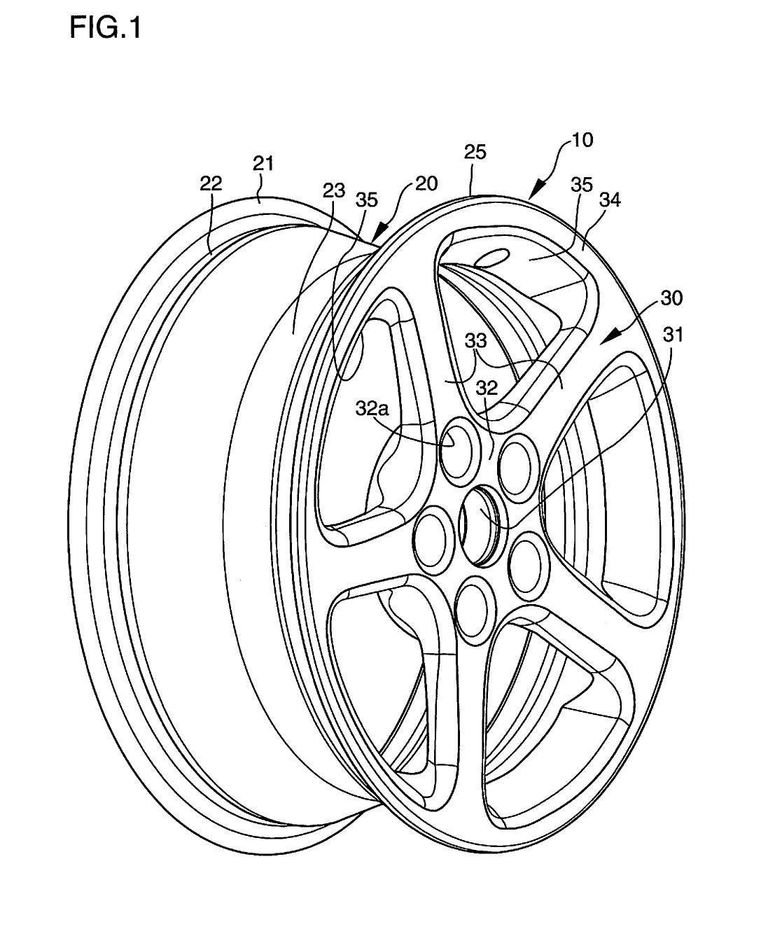

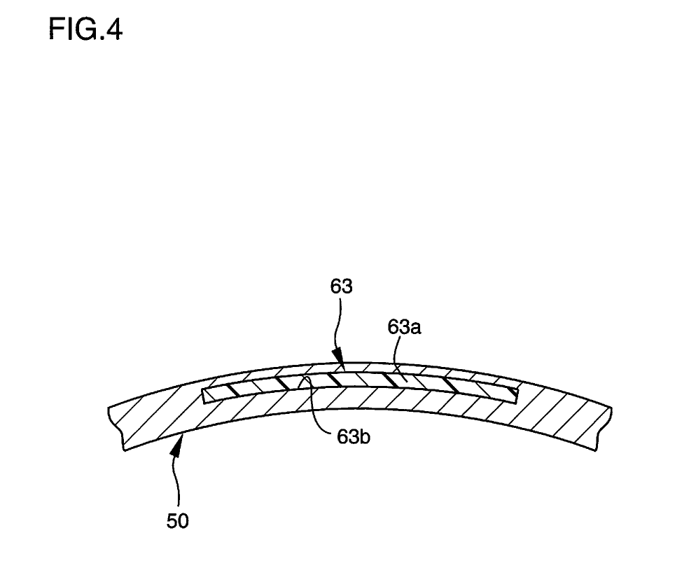

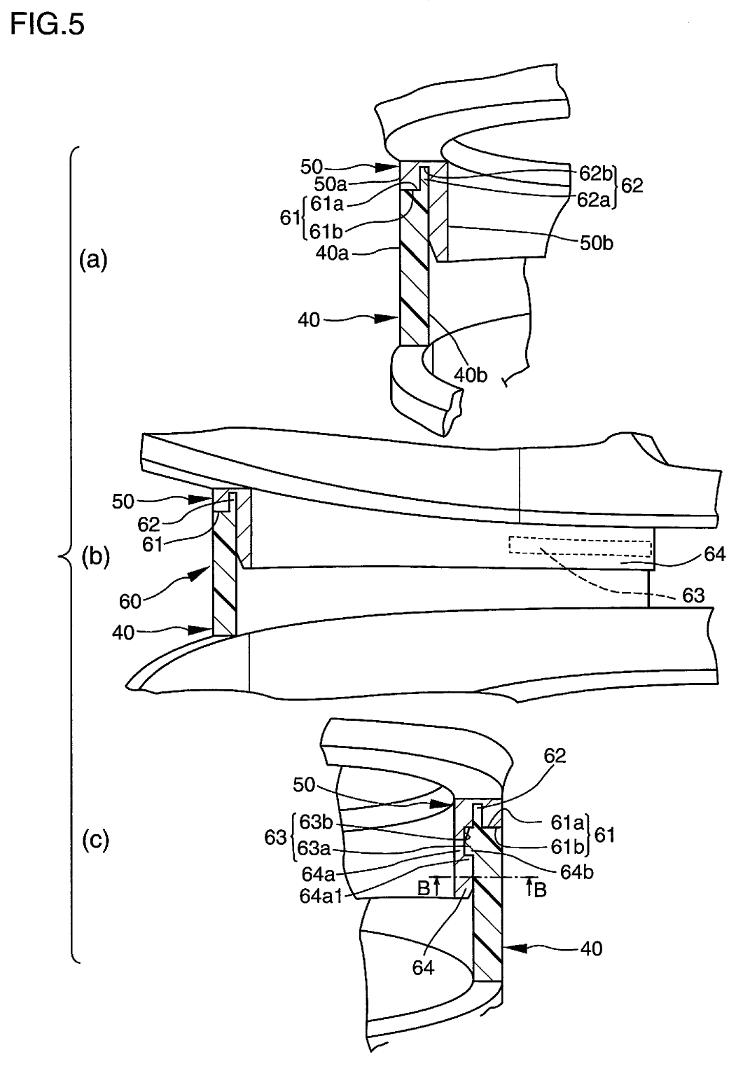

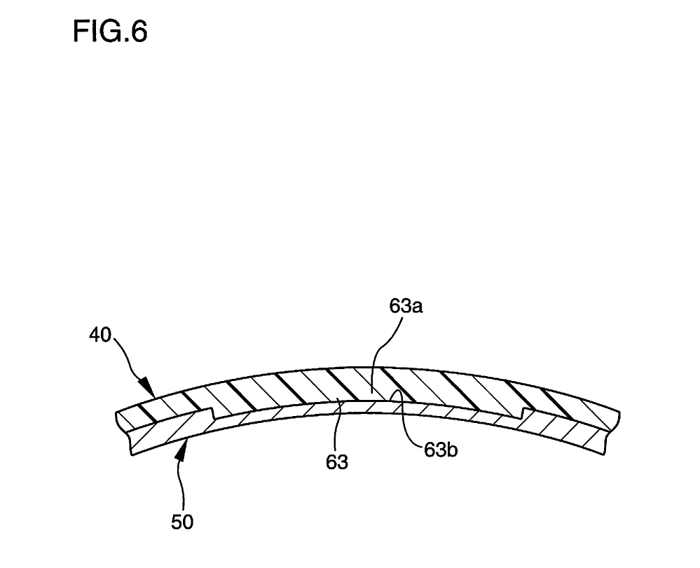

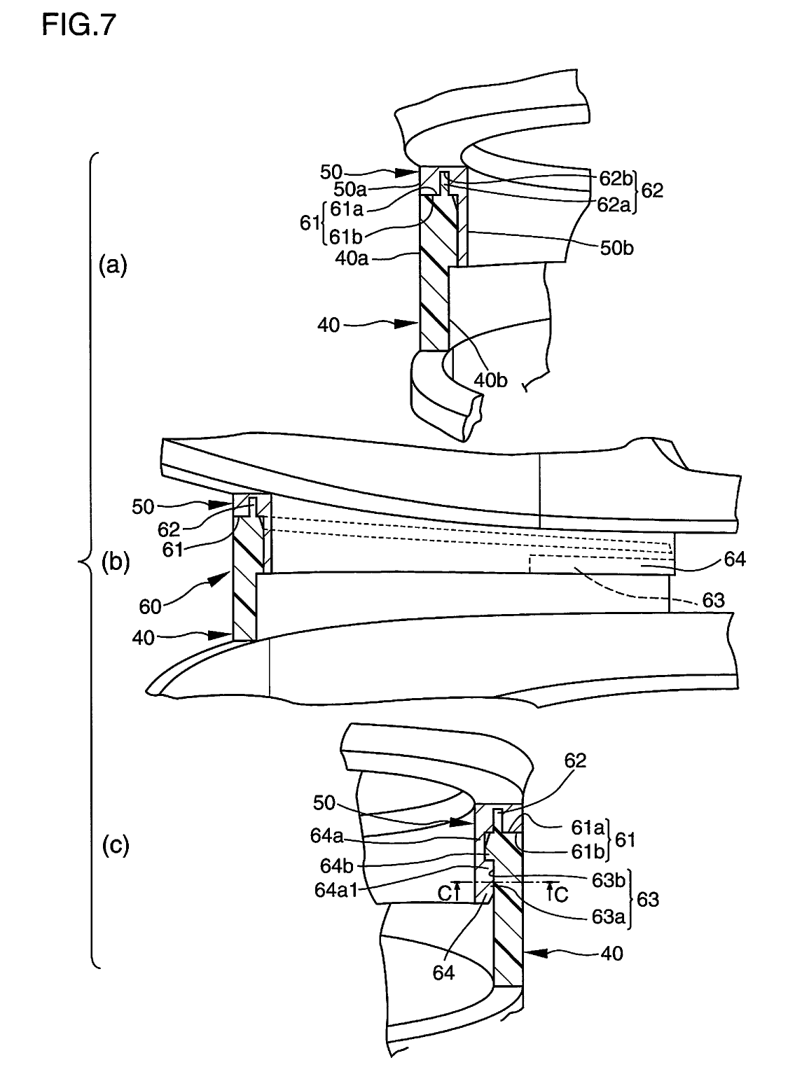

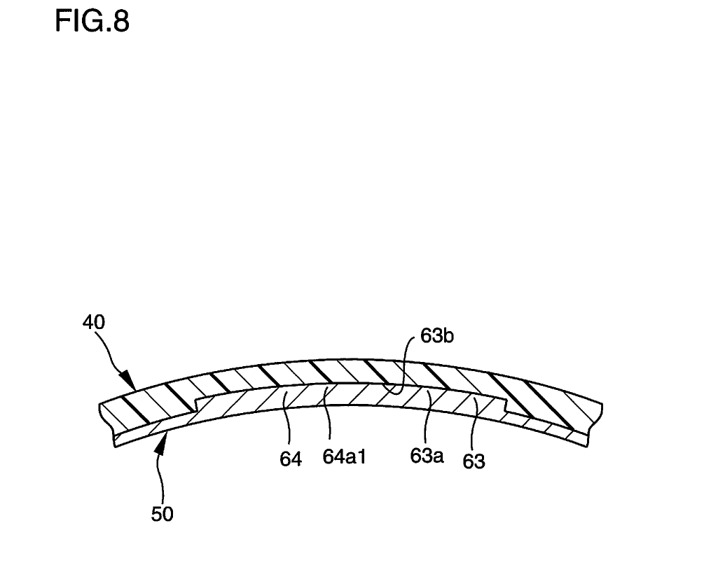

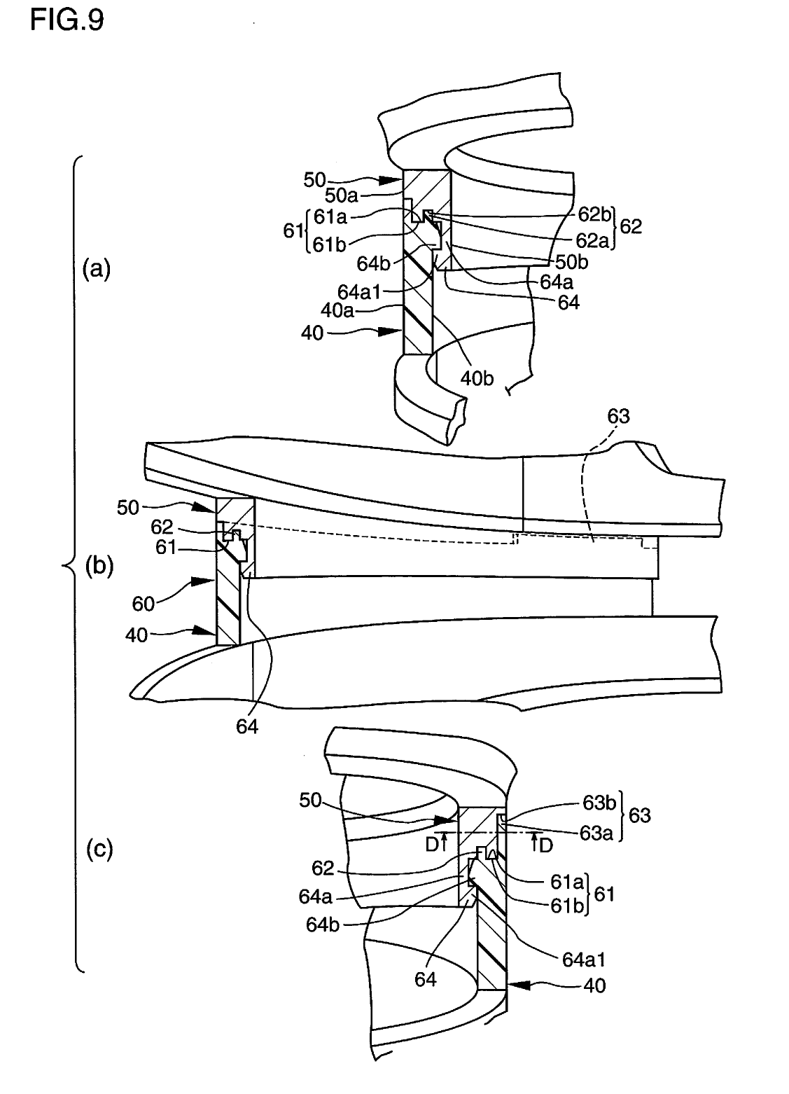

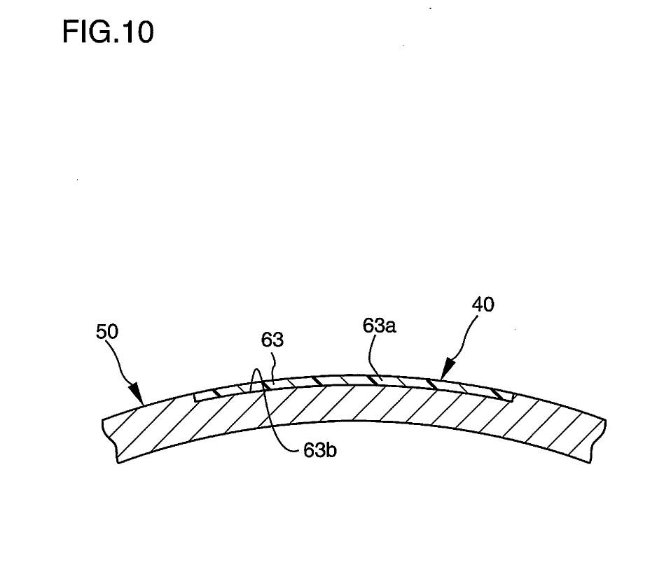

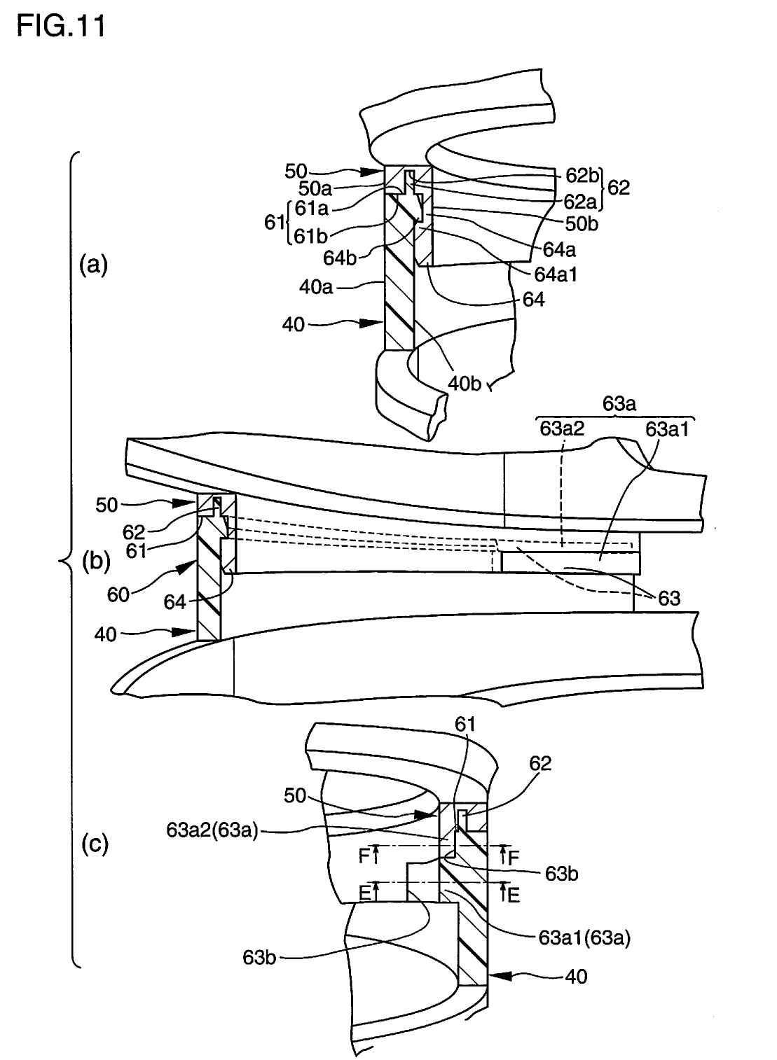

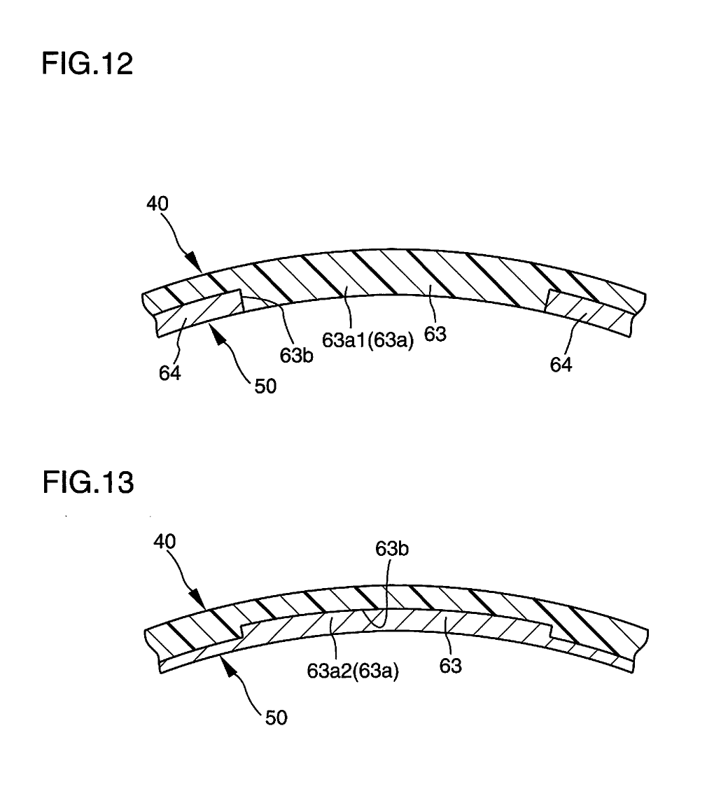

FIGS. 1 to 4 illustrate a vehicle wheel according to a first embodiment of the present invention, FIGS. 5 and 6 illustrate a vehicle wheel according to a second embodiment of the present invention, FIGS. 7 and 8 illustrate a vehicle wheel according to a third embodiment of the present invention, FIGS. 9 and 10 illustrate a vehicle wheel according to a fourth embodiment of the present invention, and FIGS. 11 to 13 illustrate a vehicle wheel according to the fifth embodiment of the present invention.

Portions common to all embodiments of the invention are denoted with the same reference numerals throughout all embodiments of the present invention. First, portions common to all embodiments of the present invention will be explained.

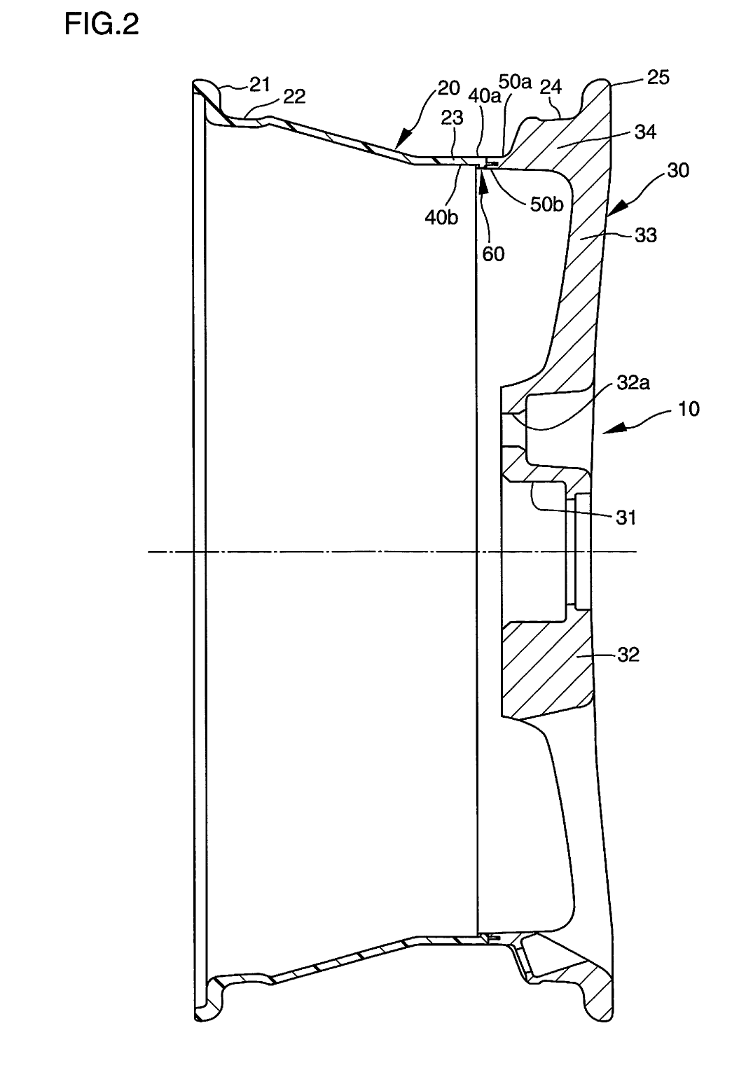

As illustrated in FIGS. 1 and 2, a vehicle wheel (hereinafter, also simply referred to as a wheel) 10 according to an embodiment of the present invention includes a rim 20 and a disk 30.

As illustrated in FIG. 2, the rim 20 includes an inboard rim flange 21, an inboard rim bead seat 22, a rim drop 23, an outboard rim bead seat 24, and an outboard rim flange 25 in order in an axial direction of the wheel. The outboard rim flange 25 and the outboard rim bead seat 24 are located toward an outer side of the vehicle in the axial direction of the wheel from the inboard rim bead seat 22 and the inboard rim flange 21 when the wheel 10 is mounted on a vehicle.

The disk 30 includes a hub hole 31, a hub coupling portion 32, a spoke 33, and a disk flange 34. However, a configuration of the disk 30 is not limited to a spoke type having the spoke 33. The disk 30 may take any other configuration such as a dish type and a mesh type. That is, since a styling of the disk 30 can be freely designed, there can be a design which is not a spoke type. In the embodiments of the present invention, a case where the shape of the disk 30 is a spoke type will be described.

The hub hole 31 is provided at a center portion of the disk 30 in a radial direction of the wheel. The hub coupling portion 32 is provided around the hub hole 31. A plurality of bolt holes 32a is provided at the hub coupling portion 32. The bolt holes 32a are provided at equal intervals in a circumferential direction of the hub coupling portion 32. When mounted on a vehicle, a hub bolt (not shown) extending from a hub is inserted through the bolt hole 32a and a hub nut (not shown) is screwed to the hub bolt so that the wheel 10 is fixed to the hub.

As illustrated in FIG. 1, the spoke 33 extends radially outward in a radial direction of the wheel from the hub coupling portion 32 to the disk flange 34. When viewed in the axial direction of the wheel, the spoke 33 may extend straight from the hub coupling portion 32 to the disk flange in the radial direction of the wheel, or may extend in a shape other than straight. Five spokes 33 are provided at equal intervals in a circumferential direction of the wheel. However, the number of the spokes 33 is not limited to five, and may be two, three, four, six or more as long as a plurality of spokes 33 are provided. A space between two spokes 33 adjacent in the circumferential direction of the wheel is a decoration hole 35.

The disk flange 34 is located at or near the outer end portion of the disk 30 in the wheel radial direction. The disk flange 34 is shaped in a form of a ring and connects the radially outer end portions of the plurality of spokes 33 in the circumferential direction of the wheel.

As illustrated in FIG. 2, the wheel 10 is constructed by assembling a first wheel piece (which may be called as a first wheel part or a first wheel portion) 40 and a second wheel piece (which may be called as a second wheel part or a second wheel portion) 50. That is, the wheel 10 is a two-piece wheel including the first and second wheel pieces 40, 50.

The first wheel piece 40 includes a portion of the rim 20 including at least the inboard rim flange 21. The second wheel piece 50 includes a remaining portion of the rim 20 and the disk 30. In the illustrated embodiment of the present invention, the first wheel piece 40 includes the inboard rim flange 21 of the rim 20, the inboard rim bead seat 22, and a portion of the rim drop 23 from an inboard end to an intermediate portion of the rim drop 23 in the wheel axial direction. The second wheel piece 50 includes the disk 30, the outboard rim flange 25, the outboard rim bead seat 24, and a portion of the rim drop 23 from an outboard end to the intermediate portion of the rim drop 23 in the wheel axial direction. Hereinafter, this configuration will be regarded as the embodiment of the present invention.

The first and second wheel pieces 40, 50 may be made from the same material or different materials. More particularly, the first and second wheel pieces 40 and 50 may be a combination of different kinds of metals, or may be a combination of a resin such as CFRP (Carbon Fiber Reinforced Plastics) and a metal.

It is preferable that the first wheel piece 40 is made from CFRP and the second wheel piece 50 including the disk 30 is made from an alloy of light metal such as aluminum or magnesium.

It is desirable to make the first wheel piece 40 from CFRP for the following reasons. First, it is advantageous in reducing the weight of the wheel 10. Second, unlike a case where both the first and second wheel pieces 40 and 50 (the entire wheel) are made from CFRP, the first wheel piece 40 of the same design can be commonly used for a plurality of designs of wheels. By using the same rim diameter and width for a plurality of designs of wheels, a mass production effect can be enhanced, because only one set of molding dies for the first wheel piece 40 made of CFRP has to be prepared. Also, an orientation of the carbon fibers is simplified and productivity can be increased since the first wheel portion 40 has only a substantially cylindrical shape.

It is desirable to make the second wheel piece 50 from a light alloy for the following reasons. Since a molding manufacturing method is usually used, there is considerable design freedom so that production of both medium grade and high grade products, with various options, is facilitated. Further, since there is no first wheel portion 40, it is advantageous for directive solidification (so that shrinkage cavities hardly occur in the disk flange 34). Furthermore, since a horizontal molding die is no longer required for the casting, it is possible to reduce the cost of the molding die, since a simple structure of two upper and lower parts can be used. Furthermore, an arrangement of the cooling system is also easy, and castability and productivity can be improved. In addition, it is also possible to reduce the volume of the heat-treatment bucket, the painting booth and the disk workpiece.

The first and second wheel pieces 40, 50 are coupled to each other by a physical assembly such as fitting, engagement, insertion, or press fitting, etc. Welding and bolt-coupling are unnecessary in the assembly. In order to obtain a sealing property between the first and second wheel pieces 40 and 50, it is desirable that a sealant is disposed between the first wheel piece 40 and the second wheel piece 50.

It is desirable that radially outer surfaces 40a and 50a of coupling portions of the first and second wheel pieces 40 and 50 are smoothly connected to each other (for example, flush to each other). This is because if there is a step in the rim drop 23, there is a possibility of damaging the bead of the tire at the time of attaching or detaching the tire (not shown), and because the damage of the bead of the tire can be suppressed by the smooth connection of the radially outer surfaces 40a and 50a of coupling portions of the first and second wheel pieces 40 and 50.

The radially inner surfaces 40b and 50b of the coupling portions of the first and second wheel pieces 40 and 50 need not be smoothly connected, but may be staggered in the radial direction of the wheel. However, the radially inner surfaces 40b and 50b of the coupling portions of the first and second wheel pieces 40 and 50 may be smoothly connected to each other.

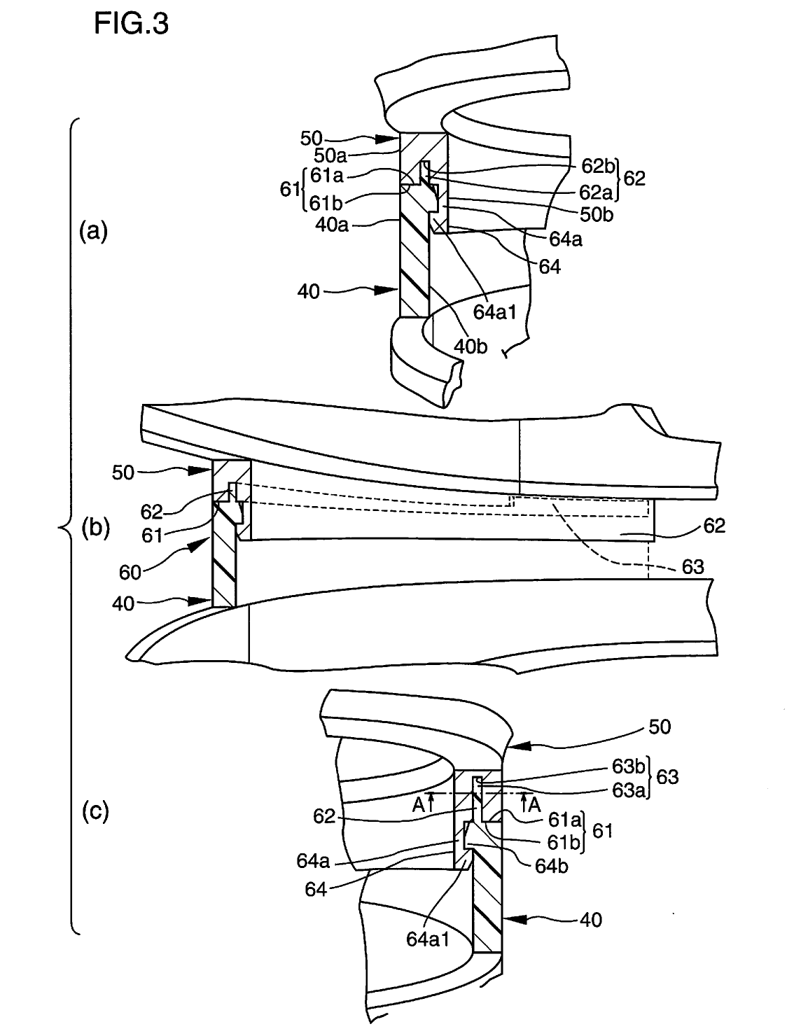

As illustrated in FIG. 3, the coupling structure 60 of the first and second wheel pieces 40 and 50 includes: (a) butting surface portion 61, (b) a radially-positioning coupling 62 for radially positioning the first wheel piece 40 and the second wheel piece 50 relative to each other in a radial direction of the wheel 10, (c) a circumferentially-positioning coupling 63 for preventing the first wheel piece 40 and the second wheel piece 50 from moving (or being dislocated) relative to each other in a circumferential direction of the wheel 10 and (d) an axially-positioning coupling 64 for preventing the first wheel piece 40 and the second wheel piece 50 from moving relative to each other in an axial direction of the wheel 10.

The butting surface portion 61 includes a first butting surface 61a provided at the first wheel piece 40 and a second butting surface 61b provided at the second wheel piece 50 and butted to the first butting surface 61a in the axial direction of the wheel.

The radially-positioning coupling 62 includes a radially-positioning protrusion 62a protruding in the axial direction of the wheel from one of the first and second wheel pieces 40 and 50 and a radially-positioning recess 62b, provided at the other of the first and second wheel pieces 40 and 50, for receiving the radially-positioning protrusion 62a.

The circumferentially-positioning coupling 63 includes a circumference protrusion (which may be called a protrusion on a circumference) 63a protruding in the axial or radial direction of the wheel from a circumferentially one portion of one of the first and second wheel pieces 40 and 50 and a circumference protrusion-receiving recess 63b, provided at the other of the first and second wheel pieces 40 and 50, for receiving the circumference protrusion 63a.

The axially-positioning coupling 64 includes an arm 64a extending in the axial direction of the wheel from one of the first and second wheel pieces 40 and 50 and having a claw (bulged portion) 64a1 bulging out in the radial direction of the wheel at a tip of the arm and a claw receiver 64b, provided at the other of the first and second wheel pieces 440 and 50, for engaging the claw 64a1 in the axial direction of the wheel.

(a) The butting surface portion 61 is formed continuously over an entire circumference of the wheel in the circumferential direction of the wheel. The first butting surface 61a and the second butting surface 61b, respectively, of the butting surface portion 61 are surfaces perpendicular to the axial direction of the wheel and are butted (i.e., the surfaces are in contact) to each other in a plane perpendicular to the axial direction of the wheel. (In a case where a sealant is provided, the first and second butting surfaces 61a and 61b contact each other via the sealant.)

(b) The radially-positioning coupling 62 is provided continuously over an entire circumference of the wheel in the circumferential direction of the wheel. The radially-positioning protrusion 62a protrudes in the axial direction of the wheel from an at least a radially intermediate portion of the butting surface portion 61 at which the radially-positioning protrusion 62a is provided. The radially-positioning recess 62b is recessed in the axial direction of the wheel from a portion of the butting surface portion 61.

(c) The circumferentially-positioning coupling 63 is provided at only certain portions of a circumference of the wheel. For example, plural circumferentially-positioning couplings may be provided intermittently at equal intervals in the circumferential direction of the wheel. A circumferential length of each circumferentially-positioning coupling 63, the number of the circumferentially-positioning couplings 63, a protruding length of the circumference protrusion 63a in a protruding direction of the circumference protrusion 63a, and a depth of the circumference protrusion-receiving recess 63b can be arbitrarily set so long as a necessary strength of the circumferentially-positioning coupling 63 can be secured.

(d) The axially-positioning coupling 64 may be provided continuously over the entire circumference of the wheel in the circumferential direction of the wheel, or may be provided at certain portions of the circumference in the circumferential direction of the wheel. When the axially-positioning coupling 64 is provided at only certain portions of the circumference of the wheel in the circumferential direction of the wheel, for example, plural axially-positioning couplings 64 may be provided intermittently at equal intervals in the circumferential direction of the wheel. The arm 64a of the axially-positioning coupling 64 may be provided so as to extend in the axial direction of the wheel from a radially inner end portion of the butting surface portion 61 at which the arm 64a is provided. Alternatively, the arm 64a of the axially-positioning coupling 64 may be provided so as to extend in the axial direction of the wheel from a radially outer end portion of the butting surface portion 61 at which the arm 64a is provided. In a case where the axially-positioning coupling 64 is provided at only certain portions of the circumference of the wheel in the circumferential direction of the wheel, the number of the axially-positioning couplings 64 and a circumferential length of the axially-positioning couplings 64 can be arbitrarily set so long as the required strength of the axially-positioning couplings 64 can be secured. A bulging amount of the claw 64a1 of the axially-positioning portion 64 in the radial direction of the wheel can be arbitrarily set so long as the required strength of the axially-positioning couplings 64 can be secured. The claw 64a1 is brought into engagement with the claw receiver 64b when the arm 64a is caused to elastically spring-back to its original position (by being deformed).

Now, effects and technical advantages common to all embodiments of the present invention will be described.

In each embodiment of the present invention, the coupling structure 60 for coupling the first and second wheel pieces 40 and 50 includes the radially-positioning coupling 62, the circumferentially-positioning coupling 63 and the axially-positioning coupling 64. The radially-positioning coupling 62 includes the radially-positioning protrusion 62a and the radially-positioning recess 62b. The circumferentially-positioning coupling 63 includes the circumference protrusion 63a and the circumference protrusion-receiving recess 63b. The axially-positioning coupling 64 includes the arm 64a and the claw receiver 64b. Therefore, even if welding and coupling by a bolt are eliminated, the first and second wheel pieces can be coupled together by a physical assembly (assembly by fitting, engaging, inserting, press-fitting, etc.).

As a result, in spite of eliminating welding and coupling by a bolt, it is possible to couple the first and second wheel pieces 40 and 50 by the above physical assembly, so that compared with the case where welding and coupling by a bolt, the man-hours required for the coupling can be reduced. Since welding can be eliminated in coupling the first and second wheel pieces 40 and 50, it is also possible to couple the first and second wheel pieces made from different materials, for example, a combination of different metals, or a combination of a resin such as CFRP and a metal. Since the coupling by a bolt can be eliminated in coupling the first and second wheel pieces 40 and 50, it is possible to eliminate a risk of occurrence of breakage of the bolt.

In a case where a sealant is disposed between the first wheel piece 40 and the second wheel piece 50, even if the first and second wheel pieces 40 and 50 are made from different metals, a risk of electrolytic corrosion due to the contact of the different metals can be suppressed as compared with a conventional wheel having no sealant.

In addition, since it is possible to paint the parts beforehand, the risk of electrolytic corrosion due to contact of different metals can be further suppressed.

Since the first and second wheel pieces 40 and 50 are coupled with each other by a physical assembly, if an impact input such as an impact due to curbstones and pot holes is received directly by the physical assembly, separation of the first and second wheel pieces 40 and 50 may happen.

However, in embodiments of the present invention, the first wheel piece 40 includes the inboard rim flange 21, the inboard rim bead seat 22, and a portion of the rim drop 23 from the inboard rim bead seat 22 to an axially intermediate portion of the rim drop 23. The second wheel piece 50 includes the disk 30, the outboard rim flange 25, the outboard rim bead seat 24, and a portion of the rim drop 23 from the outboard rim bead seat 24 to the axially intermediate portion of the rim drop 23.

Therefore, the impact input to the outboard rim flange 25 is received by the disk flange 34, so that the impact input is not received directly by the coupling portion of the first and second wheel pieces 40 and 50. In the case where the second wheel piece 50 is made from a light alloy, a destruction mode of the two-piece wheel by the impact input is the same as that of a normal one-piece light alloy wheel. On the other hand, even in a case of an impact input to the inner rim flange 21, the impact input is transmitted to the coupling portion of the first and second wheel pieces 40 and 50 via the inboard rim bead seat 22 and the rim drop 23, so that the impact input is not received directly by the coupling portion of the first and second wheel pieces 40 and 50. Therefore, it is possible to restrain direct impact input from being applied to the assembled portions of the first and second wheel portions 40, 50.

Therefore, a risk that an external input damages the coupling portion of the first and second wheel pieces 40 and 50 is extremely low.

Next, portions unique to each embodiment of the present invention will be explained.

### [First Embodiment] (FIGS. 1 to 4)

In the first embodiment of the present invention, the following structures are adopted:

(A) As illustrated in FIG. 3, the radially-positioning protrusion 62a of the radially-positioning coupling 62 protrudes from the first butting surface 61a of the first wheel piece 40 in the axial direction of the wheel. The radially-positioning recess 62b is recessed from the second butting surface 61b of the second wheel piece 50 in the axial direction of the wheel.

(B) The circumference protrusion 63a of the circumferentially-positioning coupling 63 is provided at the first wheel piece 40 so as to protrude from a tip of the radially-positioning protrusion 62a in the axial direction of the wheel. The circumference protrusion-receiving portion 63b is provided at the second wheel piece 50 so as to be further recessed from a bottom of the radially-positioning recess 62b in the axial direction of the wheel.

(C) The axially-positioning coupling 64 is provided continuously over the entire circumference of the wheel in the circumferential direction of the wheel. The arm 64a of the axially-positioning coupling 64 extends from the second butting surface 61b in the axial direction of the wheel. The claw 64a1 is bulged radially outward in the radial direction of the wheel at the tip portion of the arm 64a.

### [Second Embodiment] (FIGS. 5 and 6)

In the second embodiment of the present invention, the following structures are adopted:

(A) The radially-positioning protrusion 62a of the radially-positioning coupling 62 protrudes from the first butting surface 61a of the first wheel piece 40 in the axial direction of the wheel. The radially-positioning recess 62b is recessed from the second butting surface 61b of the second wheel piece 50 in the axial direction of the wheel.

(B) The circumference protrusion 63a of the circumferentially-positioning coupling 63 is provided at the first wheel piece 40 so as to protrude from the first wheel piece 40 radially inward in the radial direction of the wheel. The circumference protrusion-receiving portion 63b is provided at the second wheel piece 50 and is provided at the arm 64a of the axially-positioning coupling 64.

(C) The axially-positioning coupling 64 is provided at only one portion of the circumference of the wheel in the circumferential direction of the wheel. The axially-positioning coupling 64 is provided only at the same position as the circumferentially-positioning coupling 63 in the circumferential direction of the wheel. The arm 64a of the axially-positioning coupling 64 extends from the second butting surface 61b in the axial direction of the wheel. The claw 64a1 is bulged radially outward in the radial direction of the wheel at the tip portion of the arm 64a.

### [Third Embodiment] (FIGS. 7 and 8)

In the third embodiment of the present invention, the following structures are adopted:

(A) The radially-positioning protrusion 62a of the radially-positioning coupling 62 protrudes from the first butting surface 61a of the first wheel piece 40 in the axial direction of the wheel. The radially-positioning recess 62b is recessed from the second butting surface 61b of the second wheel piece 50 in the axial direction of the wheel.

(B) The circumference protrusion 63a of the circumferentially-positioning coupling 63 coincides with the claw 64a1 of the arm 64a of the axially-positioning coupling 64. The circumference protrusion 63a of the circumferentially-positioning coupling 63 is provided at the second wheel piece 50. The circumference protrusion-receiving portion 63b is provided at the first wheel piece 40.

(C) The axially-positioning coupling 64 is provided at only one portion of the circumference of the wheel in the circumferential direction of the wheel. The axially-positioning coupling 64 is provided only at the same position as the circumferentially-positioning coupling 63 in the circumferential direction of the wheel. The arm 64a of the axially-positioning coupling 64 extends from the second butting surface 61b in the axial direction of the wheel. The claw 64a1 is bulged radially outward in the radial direction of the wheel at the tip portion of the arm 64a.

### [Fourth Embodiment] (FIGS. 9 and 10)

In the fourth embodiment of the present invention, the following structures are adopted:

(A) The radially-positioning protrusion 62a of the radially-positioning coupling 62 protrudes from the first butting surface 61a of the first wheel piece 40 in the axial direction of the wheel. The radially-positioning recess 62b is recessed from the second butting surface 61b of the second wheel piece 50 in the axial direction of the wheel.

(B) The circumference protrusion 63a of the circumferentially-positioning coupling 63 is provided at the first wheel piece 40 and is located radially outward with respect to the radially-positioning protrusion 62a in the radial direction of the wheel. The circumference protrusion 63a axially protrudes in the axial direction of the wheel from a radially outer end portion of the first butting surface 61a. The circumference protrusion-receiving recess 63b is provided at the second wheel piece 50 and is located radially outward with respect to the radially-positioning recess 62b in the radial direction of the wheel. The circumference protrusion-receiving recess 63b is axially recessed in the axial direction of the wheel from a radially outer end portion of the second butting surface 61b.

(C) The axially-positioning coupling 64 is provided continuously over the entire circumference of the wheel in the circumferential direction of the wheel. The arm 64a of the axially-positioning coupling 64 extends from the second butting surface 61b in the axial direction of the wheel. The claw 64a1 is bulged radially outward in the radial direction of the wheel at the tip portion of the arm 64a.

### [Fifth Embodiment] (FIGS. 11 to 13)

In the fifth embodiment of the present invention, the following structures are adopted:

(A) The radially-positioning protrusion 62a of the radially-positioning coupling 62 protrudes from the first butting surface 61a of the first wheel piece 40 in the axial direction of the wheel. The radially-positioning recess 62b is recessed from the second butting surface 61b of the second wheel piece 50 in the axial direction of the wheel.

(B) The circumference protrusion 63a of the circumferentially-positioning coupling 63 includes the circumference protrusion 63a1 provided at the first wheel piece 40 and the circumference protrusion 63a2 provided at the second wheel piece 50. The circumference protrusions 63a1 and 63a2 are located at the same position in the circumferential direction of the wheel and at different positions in the axial direction of the wheel.

(C) The axially-positioning coupling 64 is provided at only one portion of the circumference of the wheel in the circumferential direction of the wheel. The axially-positioning coupling 64 is provided only at a position different from that of the circumferentially-positioning coupling 63 in the circumferential direction of the wheel. The arm 64a of the axially-positioning coupling 64 extends from the second butting surface 61b in the axial direction of the wheel. The claw 64a1 is bulged radially outward in the radial direction of the wheel at the tip portion of the arm 64a.

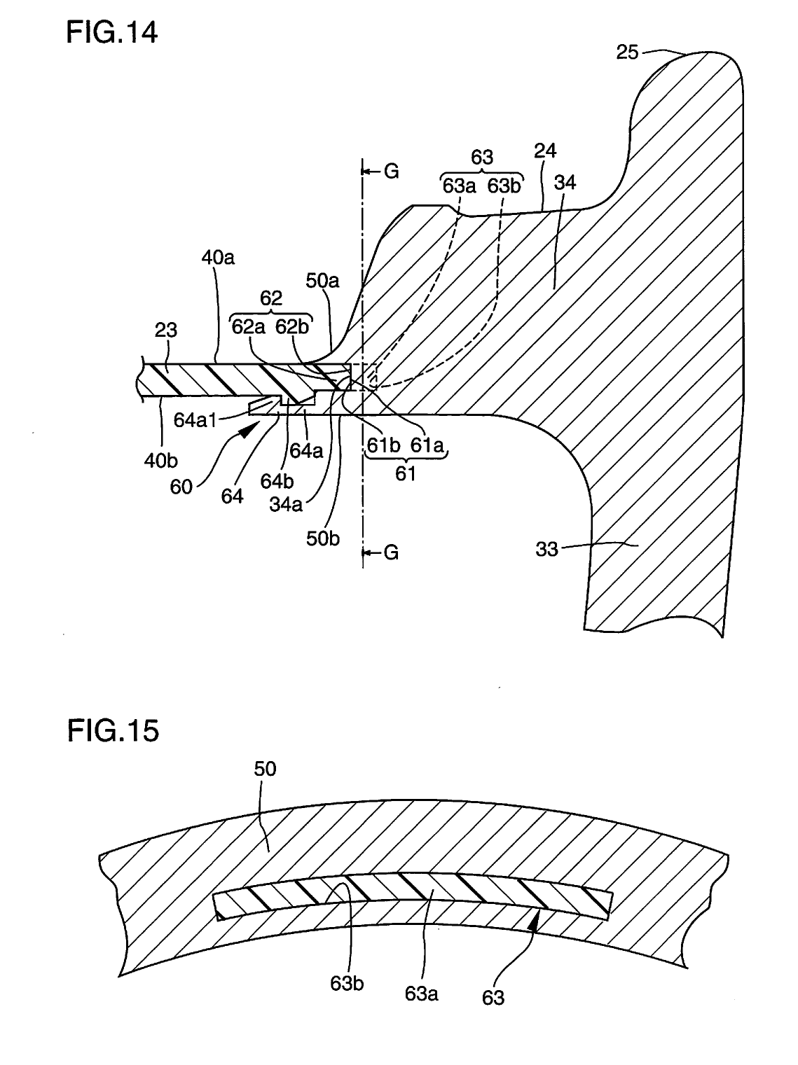

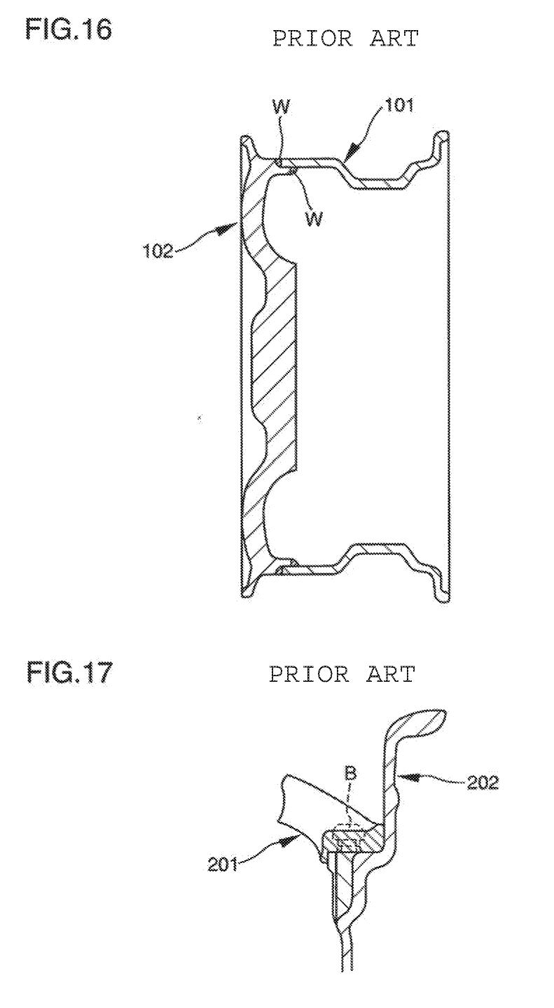

### [Sixth Embodiment] (FIGS. 14 and 15)

In the sixth embodiment of the present invention, the following structures are adopted:

(A) As illustrated in FIG. 14, the second butting surface 61b of the butting surface portion 61 is defined by a deepest surface of the axial recess 34a (excluding a deepest surface of the axial recess of the circumferentially-positioning coupling 63) provided in the disk flange 34. That is, the second butting surface 61b is provided directly at the disk flange 34.

(B) The radially-positioning protrusion 62a of the radially-positioning coupling 62 is formed from a portion that enters the axial recess 34a. The radially-positioning recess 62b is composed of the axial recess 34a.

(C) The circumference protrusion 63a of the circumferentially-positioning coupling 63 is provided at the first wheel piece 40 and is provided so as to protrude in the axial direction of the wheel from an entirety of the axial end of the radially-positioning protrusion 62a. The circumference-protrusion-receiving recess 63b is provided at the second wheel piece 50 and is provided so as to be further recessed from the bottom of the radially-positioning recess 62b in the axial direction of the wheel.

(D) The axially-positioning coupling 64 is provided continuously over the entire circumference of the wheel in the circumferential direction of the wheel. The arm 64a of the axially-positioning coupling 64 extends from the second butting surface 61b in the axial direction of the wheel. The claw 64a1 is bulged radially outward in the radial direction of the wheel at the tip portion of the arm 64a.

According to the sixth embodiment of the present invention, since the radially-positioning recess 62b is formed from a portion that enters the axial recess 34a provided at the disk flange 34 (that is, the radially-positioning recess 62b is provided at the disk flange 34), a thickness of the member where the radially-positioning recess 62b is provided is increased, so that a thickness of the radially-positioning protrusion 62a can be increased. Therefore, machining of the radially-positioning coupling 62 becomes easy, and a strength of the radially-positioning coupling 62 can be improved.

### EXPLANATION OF REFERENCE NUMERALS

10 vehicle wheel
20 rim
21 inboard rim flange
22 inboard rim bead seat
23 rim drop
24 outboard rim bead seat
25 outboard rim flange
30 disk
31 hub hole
32 hub coupling portion
32a bolt hole
33 spoke
34 disk flange
34a axial recess
35 decoration hole
40 first wheel piece
40a radially outer surface of a coupling portion of the first wheel piece
40b radially inner surface of a coupling portion of the first wheel piece
50 second wheel piece
50a radially outer surface of a coupling portion of the second wheel piece
50b radially inner surface of a coupling portion of the second wheel piece
60 coupling structure of the first and second wheel pieces
61 butting surface portion
61a first butting surface
61b second butting surface
62 radially-positioning coupling
62a radially-positioning protrusion
62a radially-positioning recess
63 circumferentially-positioning coupling
63a, 63a1, 63a2 circumference protrusion
63b circumference protrusion-receiving recess
64 axially-positioning coupling
64a arm
64a1 claw
64b claw receiver

1. A vehicle wheel comprising:
a rim including an outboard rim flange, an outboard rim bead seat, a rim drop, an inboard rim bead seat and an inboard rim flange; and
a disk, wherein
the wheel is constructed by coupling a first wheel piece and a second wheel piece to each other by using a coupling structure, the first wheel piece including a portion of the rim including at least the inboard rim flange, the second wheel piece including a remaining portion of the rim and the disk, and
the coupling structure includes (a) a radially-positioning coupling for radially positioning the first wheel piece and the second wheel piece relative to each other in a radial direction of the wheel, (b) a circumferentially-positioning coupling for preventing the first wheel piece and the second wheel piece from moving relative to each other in a circumferential direction of the wheel and (c) an axially-positioning coupling for preventing the first wheel piece and the second wheel piece from moving relative to each other in an axial direction of the wheel,
the radially-positioning coupling including a radially-positioning protrusion protruding in the axial direction of the wheel from one of the first and second wheel pieces and a radially-positioning recess, provided at the other of the first and second wheel pieces, for receiving the radially-positioning protrusion,
the circumferentially-positioning coupling including a circumference protrusion protruding in the axial or radial direction of the wheel from a portion of one of the first and second wheel pieces and a circumference protrusion-receiving recess, provided at the other of the first and second wheel pieces, for receiving the partial circumference protrusion, and
the axially-positioning coupling including an arm extending in the axial direction of the wheel from one of the first and second wheel pieces and having a claw bulging out in the radial direction of the wheel at a tip of the arm, and a claw receiver provided at the other of the first and second wheel pieces, for engaging the claw in the axial direction of the wheel.

2. The vehicle wheel according to claim 1, wherein a material of the first wheel piece and a material of the second wheel piece are different from each other.

3. The vehicle wheel according to claim 1, wherein a sealant is disposed between the first wheel piece and the second wheel piece.
